(19) United States
(12) Patent Application Publication
(10) Pub. No.: US 2022/0321223 A1
(43) Pub. Date: Oct. 6, 2022

(54) MEDIA CONVERTER PASSIVE OPTICAL NETWORK (PON)

(71) Applicant: Infinera Corporation, San Jose, CA (US)

(72) Inventor: Ting-Kuang Chiang, Saratoga, CA (US)

(73) Assignee: Infinera Corporation, San Jose, CA (US)

(21) Appl. No.: 17/714,137

(22) Filed: Apr. 5, 2022

Related U.S. Application Data
(60) Provisional application No. 63/170,728, filed on Apr. 5, 2021.

(51) Int. Cl. H04B 10/40; H04B 10/27

(52) U.S. Cl. CPC H04B 10/40; H04B 10/27

(57) ABSTRACT

Consistent with the present disclosure, a networking system is provided whereby flexible optical bandwidth or capacity between a primary or hub node and secondary or leaf nodes is realized to reduce overall cost and power consumption. Packets are multi-cast from a high speed transceiver in the hub node (or optical line terminal (OLT) to one or more sets of low speed transceivers in the leaf node (optical network terminal (ONT) or optical network unit (ONU)) allowing sets of low speed transceivers to pool together and share the total bandwidth allocated and received from the high speed transceiver. In one example, the hub node outputs a plurality of optical subcarriers, each of which being designated for one or more leaf nodes. Accordingly, the intended leaf node output data associated with its designated optical subcarrier or subcarriers as the case may be and supplies the data to a transceiver at the client premises. Circuitry is provided in the leaf node to convert the received data carried by the subcarrier to data compatible with a transceiver at the client location. In addition, circuitry is provided in the leaf node to receive optical or electrical signals supplied from the client and convert such data to information that may be carried by one or more optical subcarriers back to the hub node. In the hub node, such information is received and converted to client compatible signals that are received by client equipment connected to the hub node.

The present patent application hereby claims priority to the provisional patent application identified by U.S. Ser. No. 63/170,728 filed on Apr. 5, 2021, the entire content of which is hereby incorporated by reference.

### BACKGROUND

Passive optical networks (PONs) are known to provide access for residential, business, mobile back/mid-haul and other applications. PONs may include a point-to-multipoint architecture whereby a primary or hub node transmits optical signals to a plurality of secondary or leaf nodes. The leaf nodes, in turn, may be connected to client premises, such as homes, businesses, or wireless installations.

After a PON has been installed, equipment upgrades may be required in order to increase data capacity at the hub and/or the leaf nodes. Conventional equipment upgrades, however, often require that the upgrades be symmetrical, such that increased in capacity at the leaf nodes collectively be matched with increases in capacity at the hub node. Such upgrades, however, may be inefficient and result in additional expense.

### SUMMARY

Consistent with an aspect of the present disclosure, a node is provided that comprises a first transceiver and a switch, which is operable to receive an output from the first transceiver. In addition a plurality of second transceivers is provided. Each of the plurality of second transceivers is coupled to the switch, such that the switch provides data, based on the output of the first transceiver, to one of the plurality of second transceivers. That second transceiver is operable to supply a modulated optical signal, which includes a plurality of optical subcarriers, each of which being a Nyquist subcarrier.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) and together with the description, serve to explain the principles of the invention.

### BRIEF DESCRIPTION OF THE DRAWINGS

FIG. 1 illustrates an optical network consistent with the present disclosure;

FIG. 2 illustrate a power spectral density plot consistent with the present disclosure;

FIG. 3a shows a detailed view of an example of an optical network consistent with the present disclosure;

FIG. 3b shows a detailed view of another example of an optical network consistent with the present disclosure;

FIG. 4 illustrates an example of a transceiver consistent with the present disclosure;

FIG. 5 shows an example of a transmitter consistent with the present disclosure;

FIG. 6 shows an example of a receiver consistent with the present disclosure;

FIG. 7 illustrates an example of a network interface device consistent with an aspect of the present disclosure;

FIG. 8 shows an example of a network interface device coupled to an ethernet switch consistent with the present disclosure; and

FIG. 9 illustrate a block diagram of a client transceiver consistent with the present disclosure.

### DESCRIPTION OF THE EMBODIMENTS

Consistent with the present disclosure, a networking system is provided whereby flexible optical bandwidth or capacity between a primary or hub node and secondary or leaf nodes is realized to reduce overall cost and power consumption. In one example, packets may be multi-cast or carried by optical signals that are power split from a high speed transceiver in the hub node (or optical line terminal (OLT) to one or more sets of low speed transceivers in the leaf node (optical network terminal (ONT) or optical network unit (ONU)) allowing sets of low speed transceivers to pool together and share the total bandwidth allocated and received from the high speed transceiver. In one example, the hub node outputs a plurality of optical subcarriers, each of which being designated for one or more leaf nodes. Accordingly, the intended leaf node output data associated with its designated optical subcarrier or subcarriers as the case may be and supplies the data to a transceiver at the client premises. Circuitry is provided in the leaf node to convert the received data carried by the subcarrier to data compatible with a transceiver at the client location. In addition, circuitry is provided in the leaf node to receive optical or electrical signals supplied from the client and convert such data to information that may be carried by one or more optical subcarriers back to the hub node. In the hub node, such information is received and converted to client compatible signals that are received by client equipment connected to the hub node.

The number of optical subcarriers designated for a particular leaf node may change based on bandwidth or capacity requirements at the leaf node. For example, one subcarrier may be designated based on initial bandwidth requirements at a particular leaf node, but if capacity requirements increase, three subcarriers may be designated for that leaf node. Such increased capacity may be realized without replacing equipment. Moreover, if the capacity requirements of the leaf nodes exceeds that of the hub, the hub may be replaced or its output combined with another hub without changing the leaf nodes, provided that the collective capacity of the hub nodes does not exceed that of the leaf nodes. Thus, an asymmetric upgrade may be realized in this example (i.e., the hub is upgraded to higher capacity) without an upgrade to the leaf nodes. Similar upgrades of the leaf nodes to higher capacities may be realized without replacing the hub equipment provided that the collective leaf node capacities do not exceed the collective hub node capacities or capacity.

Reference will now be made in detail to the present embodiment(s) (exemplary embodiments) of the present disclosure, an example(s) of which is (are) illustrated in the accompanying drawings. Wherever possible, the same reference numbers will be used throughout the drawings to refer to the same or like parts.

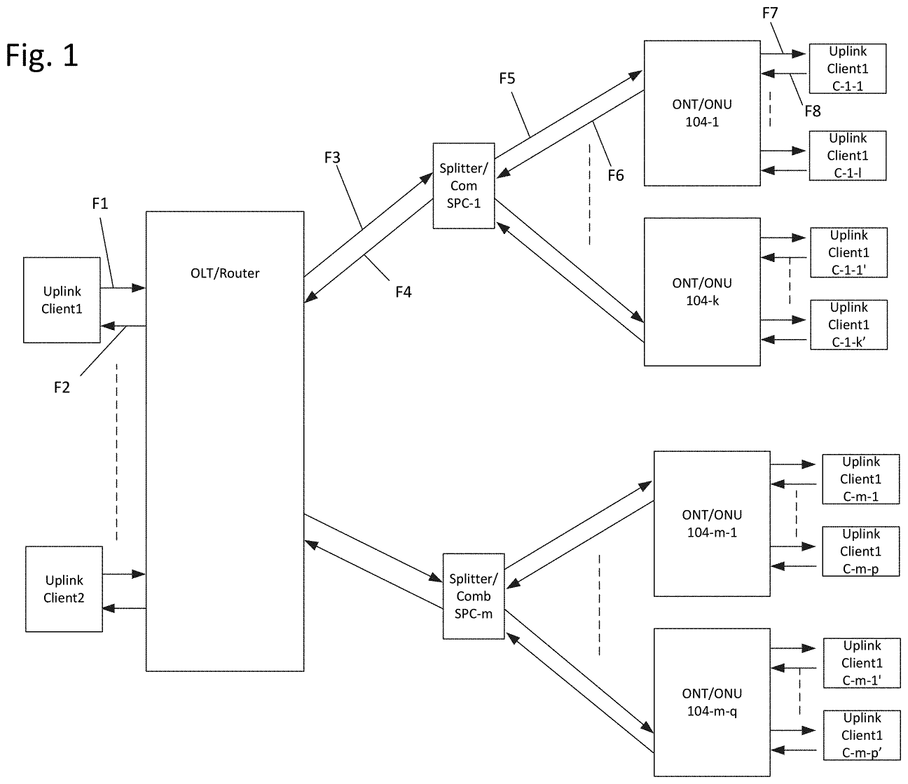

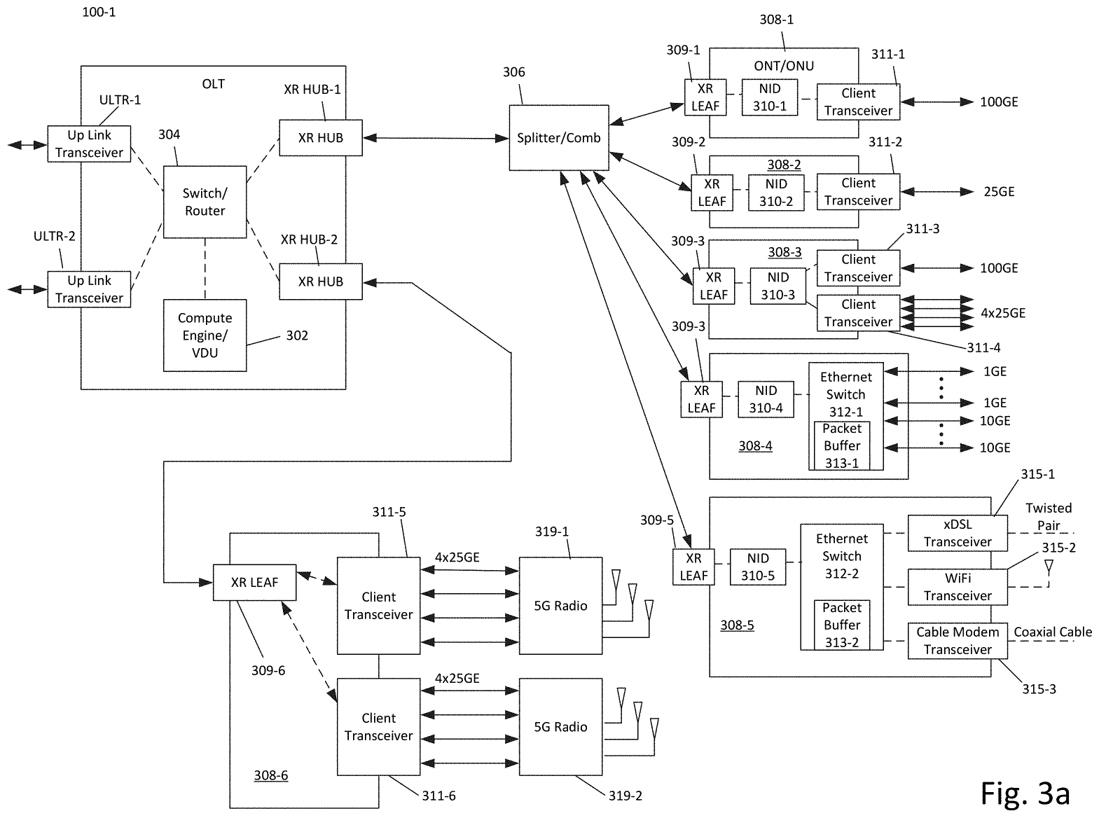

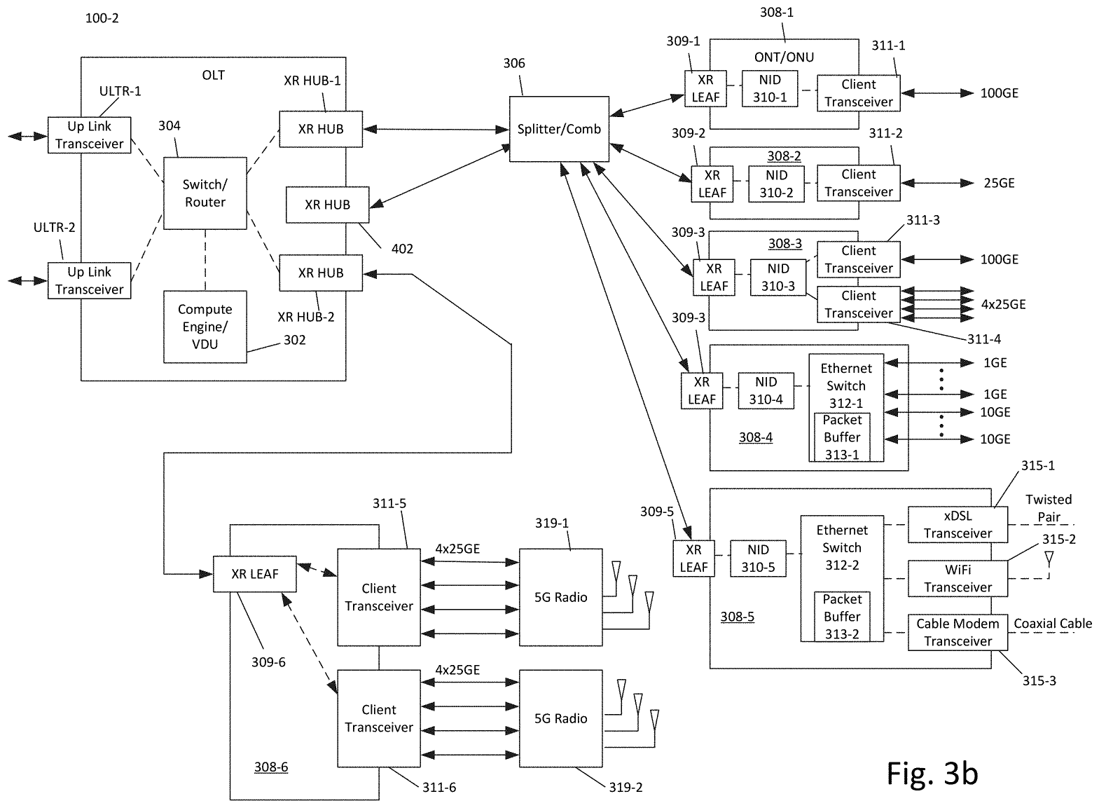

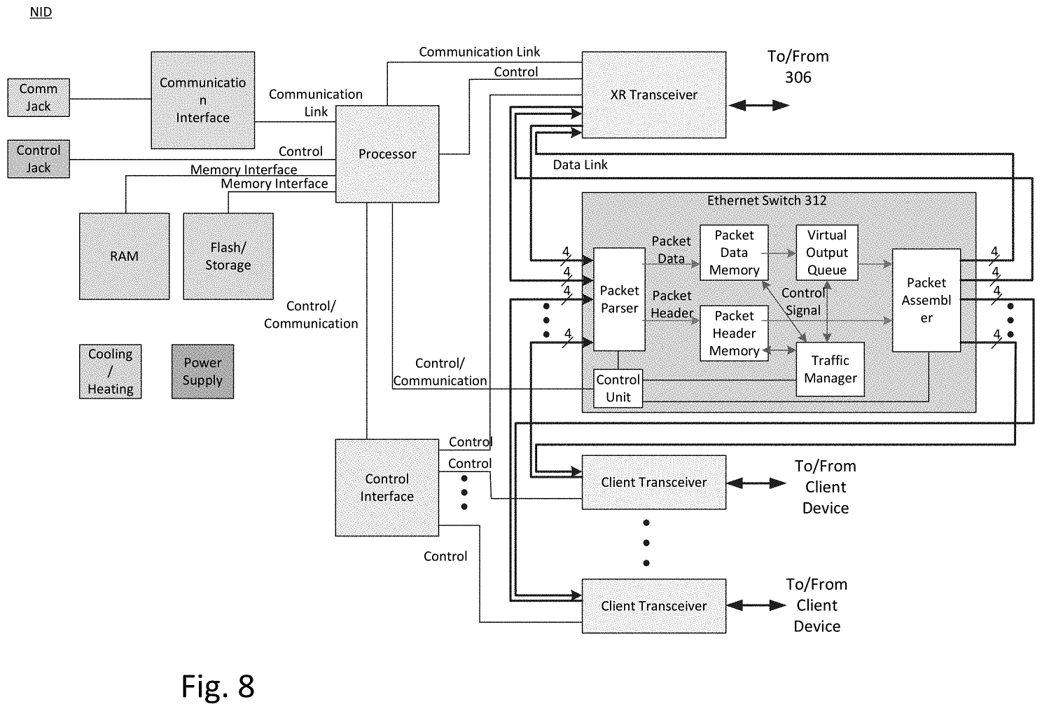

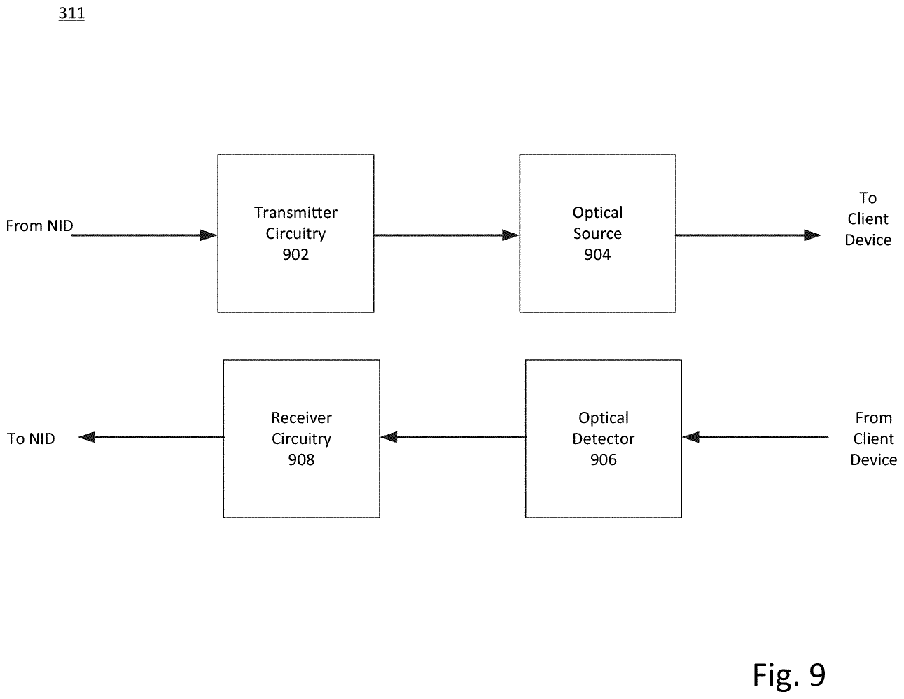

While the figures herein show examples of a network (e.g., in FIGS. 1, 3a and 3b), transceivers (e.g., in FIGS. 3a, 3b, 4-6, and 9), and other equipment (e.g., FIGS. 8 and 9) as including a particular quantity and arrangement of components, it is understood that other implementations, consistent with the present disclosure, may include additional components, fewer components, different components, or differently arranged components than that shown herein in FIGS. 1-9.

FIG. 1 shows an example of an optical communications network 100 consistent with the present disclosure. Network 100 includes a hub or OLT (including a router discussed in greater detail below) that receives data from and outputs data to a plurality of client devices or nodes Client-H1 to Client Hn. Such data may be carried by optical or electrical signals. Optical signals may be provided by optical fiber F1. OLT 102 includes components as described below that output modulated optical signals, each of which including a plurality of optical subcarriers to splitter/combiners SPC-1 to SPC-m via corresponding optical fibers (one of which is shown as optical fiber F3 that supplies a modulated optical signal to splitter/combiner SPC-1). Each splitter/combiner SPC-1 to SPC-m power splits the received optical signal and supply the pluralities of optical subcarriers to ONTs 104-1-1 to 104-1-k and ONTs 104-m-1 to 104-m-q (also referred to herein as ONUs) via optical fibers (one of which is shown as optical fiber F5 supplying a power split modulated optical signal including optical subcarriers to ONT 104-1). Based on the received modulated optical signals, ONTs 104 output optical or electrical signals carrying data to client devices C-1-1 to C-1-l to C-k-1 to C-k-l and C-m-1 to C-m-p, where k, l, m, n, p, and q are integers. Optical fibers may be employed to supply the signal output from the ONTs 104 to the client devices. For example, optical fiber F7 supplies signals from ONT 104-1 to client device C-1-1.

Data carrying electrical or optical signals may also be supplied from each of client devices C-1-1 to C-1-l to C-k-1 to C-k-l and C-m-1 to C-m-p to ONTs 104-1 to 104-k and 104-m-1 to 104-m-q. For example, client device C-1-1 may provide optical signals via optical fiber F8 to ONT 104-1. Each of the ONTs is operable to supply one or more optical subcarriers, via optical fibers, to splitters/combiners SPC-1 to SPC-m based on the received optical/electrical signals from the client devices. One such optical fiber, F6, optically couples ONT 104-1 to splitter/combiner SPC-1.

Splitters/combiners SPC-1 to SPC-m, in turn, provide combined optical subcarriers to the OLT 102 via optical fibers, such as optical fiber F4 optically coupling splitter/combiner SPC-1 to OLT 104. Based on the received optical subcarriers, OLT 102 outputs data carrying signals (either electrical or optical) to client devices Client1 to Clientn. Optical fibers, such as optical fiber F2, may be provided to supply the optical signal to the client devices. As shown, optical fiber F2 feeds optical signal output from OLT 102 to client device Client1.

Fibers F1 and F2, F3 and F4, F5 and F6, F7 and F8, in one example, constitute fiber pairs that carry optical signal in opposite directions. In an alternative embodiment, one or more of such fiber pairs may be replaced with one fiber that carries optical signals having different wavelengths or frequencies in opposite directions in that fiber.

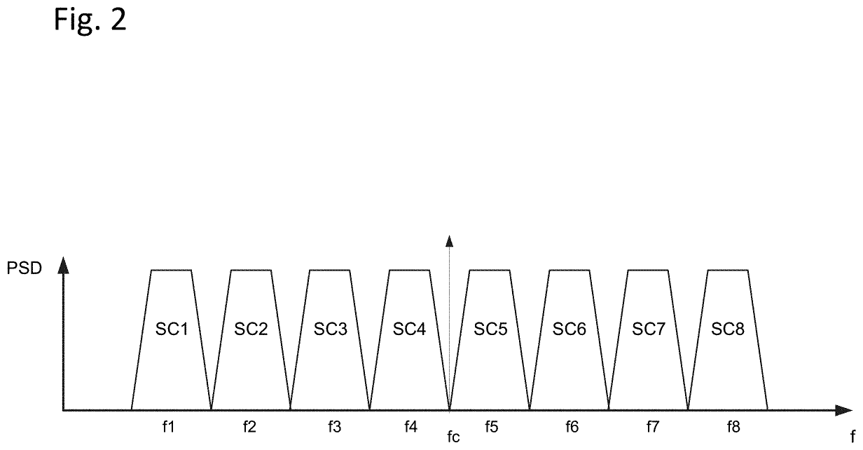

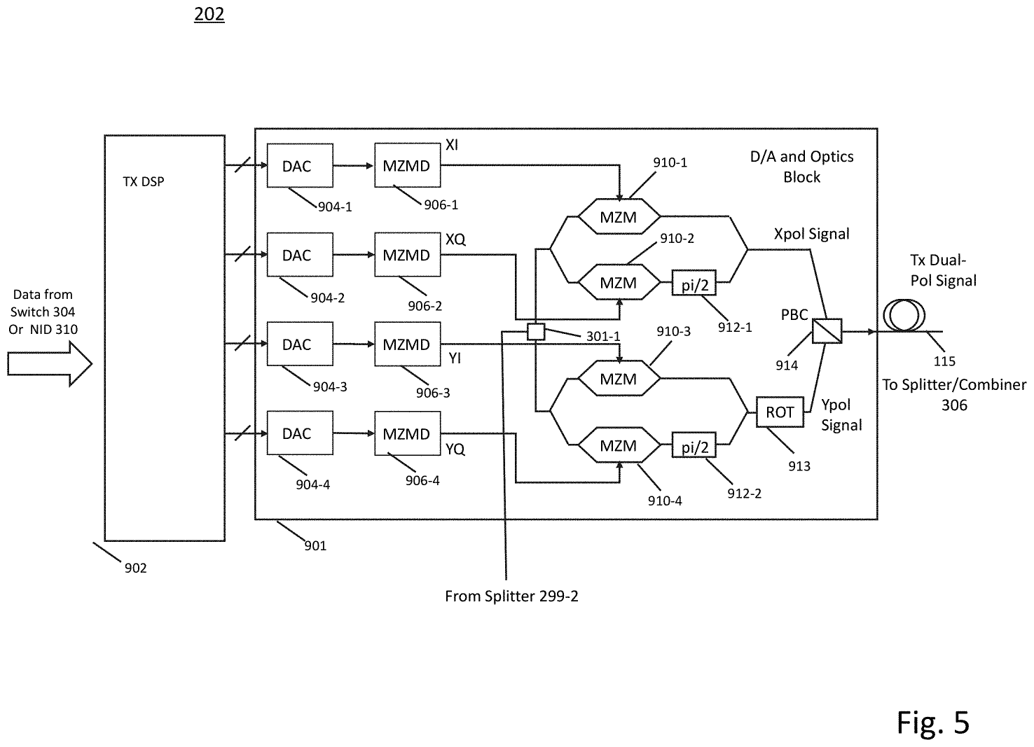

FIG. 2 illustrates an example of a power spectral density plot associated with optical subcarriers SC1 to SC8. As shown in FIG. 2, each of optical subcarriers SC1 to SC8 has a respective one of optical frequencies f1 to f8. In addition, a laser (as described below in connection with FIG. 5) supplies light or an optical signal that is subject to modulation by modulators 311 (collectively such modulators may be referred to as a modulator). Such light or optical signal is a carrier and the frequency of such carrier is shown in FIG. 2 as carrier frequency fc. Typically, half of the subcarriers (e.g., SC1 to SC4) have frequencies that are less than fc and half of the subcarriers (e.g., subcarriers SC5 to SC8) have frequencies that are greater than fc.

In some implementations, at least some of the subcarriers described can be Nyquist subcarriers. A Nyquist subcarrier is a group of optical signals, each carrying data, where (i) the spectrum of each such optical signal within the group is sufficiently non-overlapping such that the optical signals remain distinguishable from each other in the frequency domain, and (ii) such group of optical signals is generated by modulation of light from a single laser. In general, each subcarrier may have an optical spectral bandwidth that is at least equal to the Nyquist frequency, as determined by the baud rate of such subcarrier.

FIG. 3a is a detailed diagram of an example of an optical communication network 100-1 consistent with a further aspect of the present disclosure. Each solid double headed arrow in the drawing corresponds to an optical fiber pair, wherein one fiber of the pair carries optical signals in one direction and the other fiber in the pair carries optical signals in the opposite direction, as described above in connection with FIG. 1. In another example, each solid double headed arrow may also represent one fiber carrying optical signals propagating in opposite directions, as further noted above. Dashed lines and double headed arrows represent pairs of electrical conductors carrying electrical signal propagating in opposite directions, for example.

As shown in FIG. 3a, uplink transceivers ULTR-1 and ULTR-2 receive data carrying optical signals from client devices. Alternatively, ULTR-1 and ULTR-2 receive data carrying electrical signals from the client devices. Typically, the data is formatted as a series of packets, which are fed to switch or router 304. A compute engine and virtualized distribution unit (VDU) are coupled to the switch or router to determine latency among the packets. Under the control of the compute engine, the packets are supplied to transceivers XR HUB-1 and XR HUB-2, which, as discussed in greater detail below, supply modulated optical signals having a plurality of optical subcarriers to splitter 306. Splitter 306, in turn, provides a portion, e.g., a power split portion, of the modulated signal output from XR HUB-1 to each of ONUs or leaf nodes 308-1 to 308-5.

Each of ONUs 308-1 to 308-5 includes a respective one of leaf transceivers XR Leaf 309-1 to XR Leaf 309-5. In one example, each leaf transceiver is operable to detect data carried by one or more optical subcarriers based on coherent detection, as described in greater detail below. The detected data output from each of transceivers XR Leaf 309-1 to XR Leaf 309-5 to a respective one of network interface devices (NIDs) 310-1 to 310-5. In the example shown in FIG. 3a, NID 310-1 in ONU 308-1 is coupled to provide data to client transceiver 311-1, which outputs a 100 Gigabit Ethernet (GE) optical signal to a client device.

As further shown in FIG. 3a and in a similar manner, NID 310-2 in NID 308-2 outputs data to client transceiver 311-1, which supplies a 25 Gigabit Ethernet (GE) optical signal to a client device. In addition, NID 310-3 in ONU 308-3 receives data from XR leaf transceiver 309-3 and outputs data to client transceiver 311-3 and client transceiver 311-4. Client transceiver 311-3 provides a 100 GE optical output, and client transceiver 311-4 has four outputs, each of which supplying 25 GE optical signals.

XR leaf transceiver 309-4 in ONU 308-4 provides data to NID-310-4, which, in turn, supplies data to Ethernet switch 312-1, which includes a packet buffer 313-1 described in greater detail below. Ethernet switch 312-1, in one implementation, is operable to statistically multiplex output data to a plurality of 1 GE, and 10 GE outputs, each of which being coupled to a respective client device. That is, Ethernet switch 312-1 outputs data to each client device based on the demand of a particular client device at a given time. For example, if one client device requires greater bandwidth or data at one point in time, and another requires little or no data at that time, ethernet switch 312-1 directs data to the client device requiring the data rather than allocating the same capacity to each client device regardless of the bandwidth requirements at any given time.

XR leaf transceiver 309-5, NID 310-5, Ethernet switch 312-2, and packet buffer 313-2 in ONU 308-5 operate in a similar manner as corresponding components in ONU 308-4 described above. In this example, however, ethernet switch 312-2 has three outputs, each of which supplying data to a respective one of an xDSL transceiver (coupled to supply data to a twisted pair), a WiFi transceiver (coupled to supply data to an antenna) and a cable modem transceiver (coupled to supply data to a coaxial cable).

As further shown in FIG. 3a, XR leaf transceiver 309-6 in ONU 308-6 is configured to receive a modulated optical signal including a plurality of optical subcarriers from transceiver XR HUB-2. In a manner similar to that described above, XR transceiver 309-6 is operable to output data carried by one of more optical subcarriers included in the received modulated optical signal and supply such data to client transceivers 311-5 and 311-6, each of which outputting four 25 GE signal to 5G radio components 319-1 and 319-2 that output corresponding information over radio waves output from antennas coupled to the radio components.

The above disclosure of FIG. 3a describes downlink flow of data from uplink client devices coupled to uplink transceivers ULTR-1 and ULTR-2 to downlink client devices coupled to each of ONU 308-1 to 308-5 and radio wave client devices operable to receive radio wave signals from antennas coupled to the 5G radio components 319-1 and 319-2. Data may also flow upstream from downlink client devices to the uplink client devices by a process that is the reverse of that described above. For example, each of XR Leaf transceivers 309-1 to 309-2 may receive data from associated NIDs or client receivers as the case may be based on information output from downlink client devices coupled to each of ONUs 308-1 to 308-5. Based on such data, each of the XR Leaf transceivers may output one or more optical subcarriers which are combined by a combiner provided in splitter 306 and provided to transceiver XR HUB-1, which extracts the information carried by the combined optical subcarriers and outputs the information to switch 304, which, under the control of compute engine 302 supplies data to one or both of transceivers ULTR-1 and ULTR-2 for output to uplink client devices.

FIG. 3b shows network 100-2, which is similar to network 100-1, with the exception that an additional hub transceiver 402 is provided to supply a further modulated optical signal including additional optical subcarriers to splitter combiner 306. If the capacity requirements of ONUs 308 exceeds that of XR HUB-1, additional optical subcarriers carrying additional information may be provided to splitter/combiner 306, which is operable to power split the additional modulated optical signal and supply additional optical subcarriers to each ONU 308 in a manner similar to that described above. In one example, such an upgrade would not require an equipment change in the ONUs.

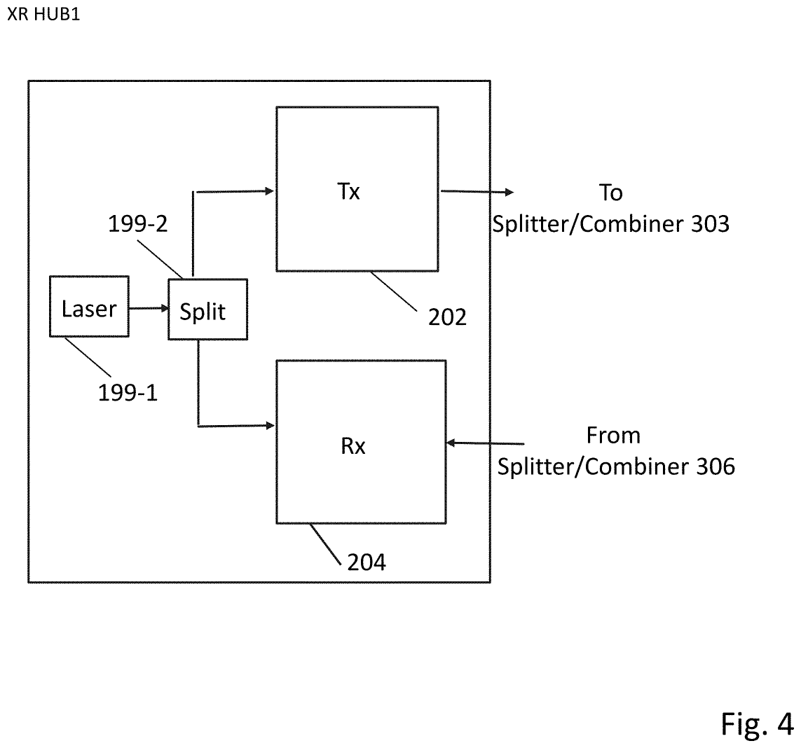

FIG. 4 illustrates transceiver XR HUB1 in greater detail. It is understood that XR HUB1, transceiver 402 and XR HUB2, as well as transceiver XR Leaf transceivers 309-1 to 309-6 have the similar construction as transceiver XR HUB1. XR HUB1 may include a transmitter or transmitter portion 202 that supplies a downlink or downstream modulated optical signal including subcarriers, and a receiver or receiver portion 204 that may receive upstream uplink subcarriers carrying data originating from the secondary nodes, such as XR Leaf transceiver 309 In one example, laser 299-1 may be provided in XR HUB1. Laser 299-1 may provide light or an optical signal to a splitter 199-2, that provides a first portion of the received light to transmitter portion 202 and a second portion of the received light to receiver portion 204. The first portion of the light output from laser 199-1 may be supplied to a modulator in transmitter 202 to provide a modulated optical signal that is output from transmitter 202. In a further example, the second portion of the light output from laser 199-1 may be supplied as a local oscillator signal to receiver 204 to facilitate detection of the incoming optical subcarriers. Thus, laser 199-1 is “shared” between transmitter 202 and receiver 204.

It is understood that transmitter 202 may have a similar construction as a transmitter provided in each XR Leaf transceiver 309 and receiver 204 may have a similar construction as the receivers provided in XR Leaf transceivers 309. The components that are included in XR HUB1, however, may support a higher bandwidth than the components included in the XR Leaf transceivers 309. In one example, such higher bandwidth is realized as the number of optical subcarriers that may be transmitted the primary and secondary nodes, such that XR HUB1, transmits more subcarriers and processes more received subcarriers than each of XR Leafs 309.

FIG. 5 shows transmitter portion 202 in greater detail. As shown in FIG. 5, transmitter portion 202 includes a DSP 902 that receives signals from switch 304, in one example, and outputs digital signals to DAC circuits 904-1 to 904-4 are provided in D/A and optics block 901 where such circuits convert digital signal received from DSP 902 into corresponding analog signals. D/A and optics block 901 also includes driver circuits 906-1 to 906-2 that receive the analog signals from DACs 904-1 to 904-4 and adjust the voltages or other characteristics thereof to provide drive signals to a corresponding one of modulators 910-1 to 910-4, as described below.

D/A and optics block 901 further includes modulators 910-1 to 910-4, each of which may be, for example, a Mach-Zehnder modulator (MZM) that modulates the phase and/or amplitude of the light output from laser 908. As further shown in FIG. 5, a portion of light from laser 299-1 output from splitter 299-2 is provided to splitter 301-1, which further splits the light, such that a first part of portion of the light supplied form splitter 301-1 is supplied to a first MZM pairing, including MZMs 910-1 and 910-2, and a second part of the light supplied from splitter 301-1 is supplied to a second MZM pairing, including MZMs 910-3 and 910-4. The first portion of the light supplied from splitter 301-1 is split further into third and fourth portions, such that the third portion is modulated by MZM 910-1 to provide an in-phase (I) component of an X (or TE) polarization component of a modulated optical signal, and the fourth portion is modulated by MZM 910-2 and fed to phase shifter 912-1 to shift the phase of such light by 90 degrees in order to provide a quadrature (Q) component of the X polarization component of the modulated optical signal. Similarly, the second portion of the light supplied from splitter 301-1 is further split into fifth and sixth portions, such that the fifth portion is modulated by MZM 910-3 to provide an I component of a Y (or TM) polarization component of the modulated optical signal, and the sixth portion is modulated by MZM 910-4 and fed to phase shifter 912-2 to shift the phase of such light by 90 degrees to provide a Q component of the Y polarization component of the modulated optical signal. As used herein, a “modulator” may refer to each modulator, such as MZMs 910-1 to 910-4, individually, or refer to such modulators collectively. For example, MZMs 910-1 to 910-4 may collectively be referred to as a “nested” Mach-Zehnder modulator.

The optical outputs of MZMs 910-1 and 910-2 are combined to provide an X polarized optical signal including I and Q components and are fed to a polarization beam combiner (PBC) 914, which, in one example, is provided in block 901. In addition, the outputs of MZMs 910-3 and 910-4 are combined to provide an optical signal that is fed to polarization rotator 913, that rotates the polarization of such optical signal to provide a modulated optical signal having a Y (or TM) polarization. The Y polarized modulated optical signal also is provided to PBC 914, which combines the X and Y polarized modulated optical signals to provide a polarization multiplexed (“dual-pol”) modulated optical signal, including one or more subcarriers, onto optical fiber 916, for example, which may be included as a segment of optical fiber in optical communication path 115 and provided to splitter/combiner 306.

Details of the structure and operation of Rx DSP 1150, Rx A/D and Optics Block 1100, will next be described.

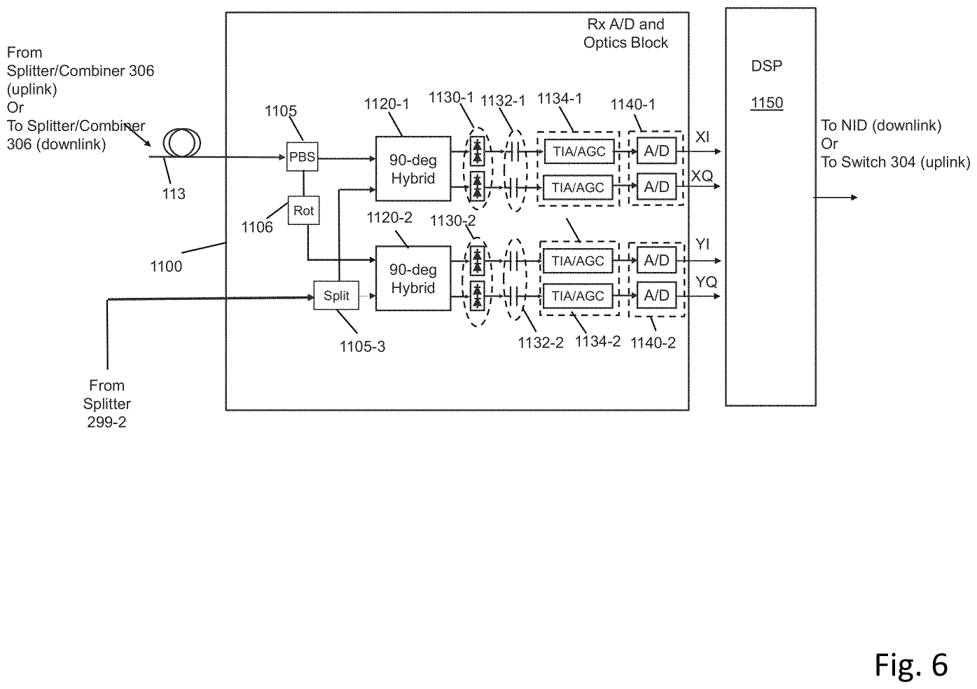

Rx A/D and Optics Block 1100 is shown in greater detail in FIG. 6. As shown in FIG. 6, Rx optics and A/D block 1100, in conjunction with Rx DSP 1150, may carry out coherent detection in receiver 302 of modulated optical signals including a plurality of optical subcarriers output from splitter/combiner 306. Block 1100 may include a polarization splitter (PBS) 1105 with first (1105-1) and second (1105-2) outputs), a local oscillator (LO) laser 1110, 90 degree optical hybrids or mixers 1120-1 and 1120-2 (referred to generally as hybrid mixers 1120 and individually as hybrid mixer 1120), detectors 1130-1 and 1130-2 (referred to generally as detectors 1130 and individually as detector 1130, each including either a single photodiode or balanced photodiode), AC coupling capacitors 1132-1 and 1132-2, transimpedance amplifiers/automatic gain control circuits TIA/AGC 1134-1 and 1134-2, ADCs 1140-1 and 1140-2 (referred to generally as ADCs 1140 and individually as ADC 1140).

Polarization beam splitter (PBS) 1105 may include a polarization splitter that receives an input polarization multiplexed optical signal including optical subcarriers, such as SC1 to SC8 (FIG. 2), from XR HUB1 via optical communication path 113. Optical communication path 113 includes, for example, an optical fiber segment, as noted above connected to splitter combiner 306 and one of ONUs 308. PBS 1105 may split the incoming optical signal into the two X and Y orthogonal polarization components. The Y component may be supplied to a polarization rotator 1106 that rotates the polarization of the Y component to have the X polarization. Hybrid mixers or 90 degree optical hybrid circuits 1120 may combine the X and rotated Y polarization components with light from local oscillator laser 1110, which, in one example, is a tunable laser. For example, hybrid mixer 1120-1 may combine a first polarization signal (e.g., the component of the incoming optical signal having a first or X (TE) polarization output from a first PBS port with light from local oscillator 1110, and hybrid mixer 1120-2 may combine the rotated polarization signal (e.g., the component of the incoming optical signal having a second or Y (TM) polarization output from a second PBS port) with the light from local oscillator 1110. In one example, polarization rotator 1190 may be provided at the PBS output to rotate Y component polarization to have the X polarization.

Detectors 1130 may detect mixing products output from the optical hybrids, to form corresponding voltage signals, which are subject to AC coupling by capacitors 1132-1 and 1132-1, as well as amplification and gain control by TIA/AGCs 1134-1 and 1134-2. The outputs of TIA/AGCs 1134-1 and 1134-2 and ADCs 1140 may convert the voltage signals to digital samples. For example, two detectors (e.g., photodiodes) 1130-1 may detect the X polarization signals to form the corresponding voltage signals, and a corresponding two ADCs 1140-1 may convert the voltage signals to digital samples (XI, XQ) for the first polarization signals after amplification, gain control and AC coupling. Similarly, two detectors 1130-2 may detect the rotated Y polarization signals to form the corresponding voltage signals, and a corresponding two ADCs 1140-2 may convert the voltage signals to digital samples (YI, YQ) for the second polarization signals after amplification, gain control and AC coupling. RX DSP 1150 may process the digital samples associated with the X and Y polarization components to output data associated with one or more subcarriers within a group of subcarriers encompassed by the bandwidth associated with the secondary node or ONU housing the particular Rx DSP 1150.

While FIG. 6 shows optical receiver component 202 as including a particular number and arrangement of components, in some implementations, optical receiver 202 may include additional components, fewer components, different components, or differently arranged components. The number of detectors 1130 and/or ADCs 1140 may be selected to implement an optical receiver 302 that is capable of receiving a polarization multiplexed signal.

Consistent with the present disclosure, in order to select a particular subcarrier or group of subcarriers at a secondary node or ONU 308, local oscillator 1110 may be tuned to output light having a wavelength or frequency relatively close to the selected subcarrier wavelength(s) to thereby cause a beating between the local oscillator light and the selected subcarrier(s). Such beating will either not occur or will be significantly attenuated for the other non-selected subcarriers so that data carried by the selected subcarrier(s) is detected and processed by Rx DSP 1150. Alternatively, circuitry in Rx DSP 1150 may be provided to selectively block not intended for a hub node or a leaf node, as well as pass or output such data from the hub or leaf node as the case may be. See U.S. Patent Application Publication No. 2020-0403704, the entire contents of which are incorporated herein by reference. Accordingly, the capacity associated with each ONU may be adjusted by to either output data associated with one or more optical subcarriers or selectively block such data. Such changes in bandwidth at the ONU, as well as at the hub, may be made, in some implementations without changing components in either the hub or ONU.

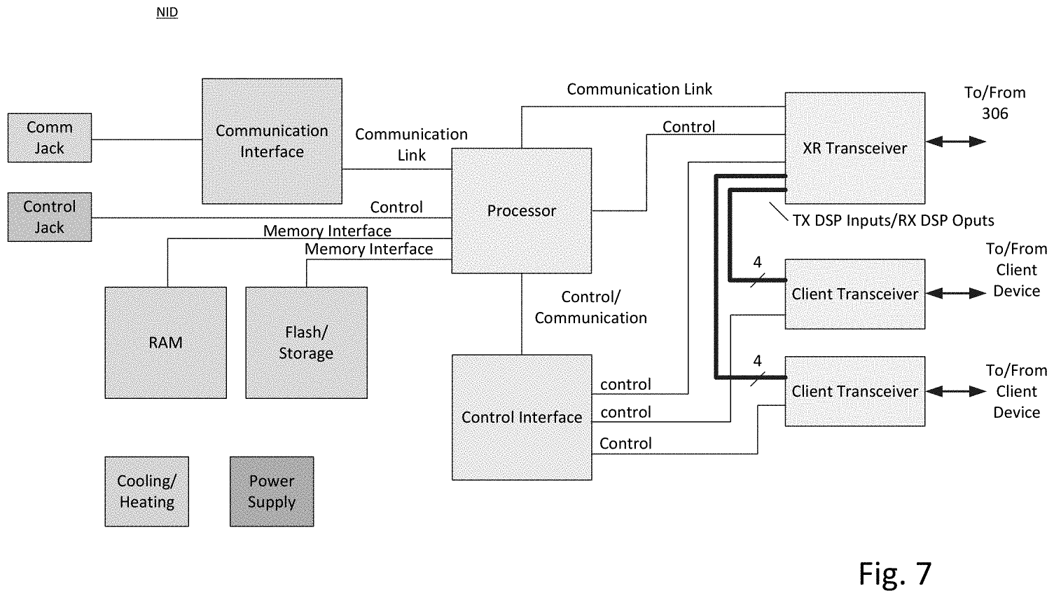

FIG. 7 shows an example of a NID in combination with an XR transceiver (either a Leaf XR transceiver or XR HUB transceiver) and a client transceiver, such as client transceivers 311 or uplink transceivers ULTR). As shown in FIG. 7, the XR transceiver outputs data to and/or receives data from client transceivers by way of the transmit and receive DSPs described above. Data output to/from the XR and client transceivers may be controlled based on control signals supplied by a process. For example, the processor may provide such control signals directly to the transceivers or to an control interface circuit which may convert the control signals to a suitable format for output to the XR and client transceivers. Alternatively, the XR transceiver may supply data at a high speed relative to the client transceiver inputs and outputs by way of a communication link. As shown in FIG. 7, the high speed communication link may provide the high speed output of the XR transceiver to the processor, which may retransmit the data to a communication interface and then output from a communication jack connected to the NID.

Control information may be provided to the processor by several different mechanisms. The control information may be provided by an external source via a control jack that is connected to the processor. In one example, a user may supply control signals for maintenance purposes through the control jack. Alternatively, control information may be stored in a random access memory (RAM) or flash storage and output from these storage devices or memories to the processor.

As further shown in FIG. 7, a power supply may be included to supply sufficient voltage and/or current to the components of the NID and the transceivers. In addition, if necessary, cooling and heating circuitry may be provided to adjust the temperature of the NID and the XR and client transceivers to an appropriate level.

FIG. 8 shows details of ethernet switch 312 provided in a NID. Other components shown in FIG. 8 are similar to those discussed above in connection with FIG. 7 and will, therefore, not be further described.

As shown in FIG. 8, Ethernet switch 312 includes a packet parser circuit that receives packets from the XR transceiver as well as the client transceivers. The Packet parser separates the header and payload (data) of each packet and provides that payload or data to a packet data memory and the packet header to a header memory. Each payload has an associated index which is stored in a virtual output queue. Under control of the traffic manager and based on the indexes, data is output from the packet data memory and header information is output from the packet header memory and supplied to a packet assembler. The packet assembler appends each header to a corresponding payload to thereby form new packets. In doing so, the information included in the header of the new packets may be changed by the traffic manager. The packet manager may then output the new packets to the XR and client transceivers for output as noted above. In addition, statistical multiplexing, as described above, may be realized by orchestrating the outputs of the packet assembler so that data is output by a transceiver to a desired client device. Such orchestration may be based on control information from a control unit, that receives such control information from one or more of the sources noted above.

FIG. 9 shows a high level block diagram of a client transceiver 311 consistent with an aspect of the present disclosure. In this example, client transceiver 311 includes transmitter circuitry 902 that receives data from the NID, as noted above. Transmitter circuitry 902 outputs signals, based on the received NID data, to optical source 904, which supplies a modulated optical signal carrying data or information to a client device. Alternatively, electrical signals associated with such data may be provided to the client device.

FIG. 9 also shows detector 906 that receives an optical signal from a client device. The resulting electrical signal output from optical detector 906 is indicative of such data. The electrical signal output from detector 906 is provided to receiver circuitry 908, which outputs appropriately formatted signals further indicative of the client data to the NID.

Other embodiments will be apparent to those skilled in the art from consideration of the specification. It is intended that the specification and examples be considered as exemplary only, with a true scope and spirit of the invention being indicated by the following claims.

What is claimed is:

1. A node, comprising:
a first transceiver;
a switch operable to receive an output from the first transceiver;
a plurality of second transceivers, each of which being coupled to the switch, such that the switch provides data, based on the output of the first transceiver, to one of the plurality of second transceivers, said one of the plurality of second transceivers being operable to supply a modulated optical signal, which includes a plurality of optical subcarriers, each of the plurality of optical subcarriers being a Nyquist subcarrier.
